(19) United States
(12) Patent Application Publication
(10) Pub. No.: US 2019/0275710 A1
(43) Pub. Date: Sep. 12, 2019

(54) METHOD FOR PRODUCING TUBULAR ARTICLE

(71) Applicant: Konia Minolta, Inc., Tokyo (JP)

(72) Inventors: Junji UJIHARA, Tokyo (JP); Tsuyoshi SHIMODA, Tokyo (JP); Takayuki SUZUKI, Niiza-shi (JP)

(21) Appl. No.: 16/267,539

(22) Filed: Feb. 5, 2019

(30) Foreign Application Priority Data
Mar. 6, 2018 (JP) 2018-039646

(51) Int. Cl. B29C 41/08; B29C 41/22; B29C 41/00; B29D 29/06

(52) U.S. Cl. CPC B29C 41/085; B29C 41/22; G03G 15/162; B29D 29/06; B29C 41/003

(57) ABSTRACT

The present invention provides a means for improving peeling durability of a tubular article to be produced and properties thereof at the time of use while having high productivity in a method for producing a tubular article. The present invention relates to the method for producing a tubular article including: continuously coating at least two coating solutions for forming a polyimide resin layer to form a stacked coating film, the two coating solutions each including a solvent-soluble polyimide; and a solvent having a vapor pressure at 25° C. of 10 kPa or more and 19 kPa or less.

### CROSS-REFERENCE TO RELATED APPLICATION

The entire disclosure of Japanese Patent Application No. 2018-039646, filed on Mar. 6, 2018, is incorporated herein by reference in its entirety.

### BACKGROUND

### 1. Technological Field

The present invention relates to a method for producing a tubular article.

### 2. Description of the Related Art

Tubular articles have been studied for use in various industrial fields and have been used for various applications such as transfer conveying belts, intermediate transfer belts, and transfer fixing belts, in an electrophotographic image forming apparatus. Here, as one electrophotographic image forming method, there is a method for transferring a toner image formed on a photoreceptor onto an intermediate transfer body and performing secondary transfer onto a recording medium from the intermediate transfer body, thereby forming an image. In addition, one embodiment of the intermediate transfer body is an intermediate transfer belt using a seamless belt (endless belt) formed with a tubular article formed of a resin.

As a method for producing a tubular article, for example, there is a known method for coating a resin solution, which is a material, to an inner peripheral surface or an outer peripheral surface of a cylindrical mold at a predetermined thickness to form a coating film, then heating the coating film to evaporate the solution, and if necessary, further curing. As the resin which is the material, a resin having optimum properties is selected appropriately depending on the application, but a polyimide resin has been generally used because of high strength and high resistance to electrical stress.

In addition, for high functionality, the tubular article has been studied to be formed with a multilayer tubular article including a combination of various layers. In addition, for high functionality, it has been proposed to stack polyimide resin layers so that properties such as electric resistance are changed at an outer surface side and an inner surface side.

JP 2013-195452 A, JP 2013-125201 A, and JP 2013-052549 A disclose a method for producing a belt having a multilayer stacked structure formed of a polyimide resin, the method including forming a first polyimide resin layer by coating a solution including a polyimide precursor on a mold, heating and drying the coating film, followed by heating and firing, and forming a second polyimide resin layer by coating a solution including a polyimide precursor an the first polyimide resin layer, heating and drying the coating film, followed by heating and firing.

JP 2013-039729 A (corresponding to US 2013/043614 A) and JP 2010-221647 A disclose a method for producing a belt having a multilayer stacked structure formed of a polyimide resin, the method including forming a first coating film by coating a solution including a polyimide precursor on a mold, followed by heating and drying, forming a second coating film by coating a solution including a polyimide precursor on the first coating film, followed by heating and drying, and heating and firing the first coating film and the second coating film.

JP 2006-215076 A discloses a method for producing a belt having a multilayer stacked structure formed of a polyimide resin, the method including mounting a substrate made of a thermosetting polyimide resin, which is obtained by coating a solution including a polyimide precursor on a cylindrical mold, heating and drying the coating film, followed by heating and firing, on an outer peripheral surface of the cylindrical mold, and coating a solution including a solvent-soluble polyimide to a surface of the substrate, followed by heating and drying to form a surface layer.

### SUMMARY

However, in conventional methods for producing a tubular article formed of a polyimide resin, productivity is not sufficient from the viewpoint that dry treatment and firing treatment by actively heating after each layer is formed are required to prevent mixing of each layer, and failure may occur in these steps.

In addition, as a solvent (dissolvent) of a solution including a polyimide precursor, in general, amide-based solvents with low vapor pressure such as N-methyl-pyrrolidone and dimethylformamide dimethylacetamide, have been used from the viewpoints of solubility, reactivity in synthesis of the polyimide precursor, reactivity of imidization at the time of firing, and the like. However, removal of these solvents from a coating film requires a high temperature and a long period of time, which further lowers the productivity.

In addition, since a lower layer coating film is fired to form a lower layer polyimide resin layer and then a coating solution for an upper layer is coated, a surface of the lower layer polyimide resin layer is hardly dissolved by a solvent of the coating solution for the upper layer, thus causing a problem that peeling durability is low. Further, in order to alleviate these problems, it is necessary to finely control drying conditions such as drying temperature, drying time, and quantity of hot wind for each layer formation, and thus productivity is further lowered, and an improvement effect is not also sufficient.

Therefore, it is an object of the present invention to provide a means capable of improving peeling durability of a tubular article to be produced and properties thereof at the time of use while having high productivity in the method for producing a tubular article.

To achieve at least one of the abovementioned objects, according to an aspect of the present invention, an embodiment of the present invention reflecting one aspect of the present invention has the following constitution.

A method for producing a tubular article, including continuously coating at least two coating solutions far forming a polyimide resin layer to form a stacked coating film, the two coating solutions each including: a solvent-soluble polyimide; and a solvent having a vapor pressure at 25° C. of 10 kPa or more and 19 kPa or less.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIGS. 1A and 1B are schematic views showing an example of a coating method in a method for producing a tubular article according to an embodiment of the present invention, wherein FIG. 1A is a schematic view when coating on an outer peripheral surface of a cylindrical mold is performed, and FIG. 1B is a schematic view when coating on an inner peripheral surface of the cylindrical mold is performed;

FIGS. 2A and 2B are schematic views showing a preferable example of a constitution of a tubular article to be produced, wherein FIG. 2A is a schematic view showing the whole of a multilayer tubular article, and FIG. 2B is a schematic cross-sectional view showing a stacked structure of the multilayer tubular article shown in FIG. 2A; and

FIG. 3 is a schematic view showing an example of an image forming apparatus using the tubular article to be produced as an intermediate transfer belt.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, a preferred embodiment of the present invention is described. In the present specification, “X to Y” indicating a range means “X or more and Y or less”. In addition, unless otherwise specifically stated, operation and measurement of physical properties, and the like, are performed under conditions of room temperature (20° C. to 25° C.)/relative humidity of 40 to 50% RH.

In addition, in the description of the drawings, the same elements are denoted by the same reference numerals, and overlapped explanations are omitted. In addition, dimensional ratios in the drawings are exaggerated for convenience of explanation and may differ from the actual ratio.

Further, in the present specification, phrases indicating arrangement of“upper layer”, “lower layer”, and the like, are used for convenience to explain a positional relationship between components. Further, the positional relationships between components change appropriately according to contents that explain each component. Therefore, the phrases are not limited to the phrases described in the specification, and can be changed appropriately according to the circumstances.

An embodiment of the present invention is a method for producing a tubular article including: continuously coating at least two coating solutions for forming a polyimide resin layer to form a stacked coating film, the two coating solutions each including: a solvent-soluble polyimide; and a solvent having a vapor pressure at 25° C. of 10 kPa or more and 19 kPa or less. Here, “continuously costing” means that a coating solution for each layer is sequentially applied without substantially performing heat treatment such as heating and drying or heating and firing during a period from the formation of the lower layer coating film to the coating of the coating solution for the upper layer on the surface of the lower layer coating film. In the present specification, “heat treatment such as heating and drying or heating and firing is not substantially performed” means that heating is not actively performed.

According to the present invention, in the method for producing a tubular article, there is provided a means capable of improving peeling durability of a tubular article to be produced and properties thereof at the time of use while having high productivity.

In addition, “properties thereof at the time of use” which is improved by an embodiment of the present invention are preferably electric properties such as surface resistivity and volume resistivity, or an image quality in an electrophotographic image forming apparatus using a tubular article according to an embodiment of the present invention or in an image forming method using the apparatus, but these properties are not limited thereto.

The method for producing a tubular article according to an embodiment of the present invention is particularly preferably used for production of a multilayer tubular article including a stacked structure in which at least two polyimide resin layers are stacked.

The present inventors have assumed the mechanism in which the problem is solved by the above constitution as follows.

As described above, in the conventional method for producing a multilayer tubular article, an amide-based solvent with low vapor pressure has been generally used as a solvent (dissolvent) of a solution including a polyimide precursor from the viewpoints of solubility, reactivity in synthesis of the polyimide precursor, reactivity of imidization at the time of firing, and the like.

Meanwhile, in an embodiment of the present invention, by using a solvent-soluble polyimide instead of the polyimide precursor as the polyimide resin which is the material of the tubular article, it is easy to select a solvent other than the amide-based solvent having a low vapor pressure. When the coating solution for the lower layer includes a solvent having a predetermined or more vapor pressure at 25° C. as a solvent (dissolvent), the solvent is removed from the lower layer coating film to the extent that the mixing of the lower layer and the upper layer as a whole is not caused even without substantially performing heating and drying after the lower layer coating film is formed. Thereby, the heating treatment is not necessary during a period from the formation of the lower layer coating film to the coating of the coating solution for the upper layer on the surface of the lower layer coating film, thereby making it possible to improve productivity. Further, when the coating solution for the upper layer includes the solvent as a solvent (dissolvent), the drying treatment time can be shortened since it is easier to remove the solvent, thereby making it possible to improve productivity.

In addition, by using the solvent-soluble polyimide, firing treatment essential for the polyimide precursor is not necessary, and thus the number of steps can be reduced, thereby making it possible to improve productivity.

In addition, by using the solvent in which a vapor pressure at 25° C. is within a predetermined range as a solvent (dissolvent) in the coating solution for forming a polyimide resin layer, it is possible to improve peeling durability of a tubular article to be produced and properties thereof at the time of use. When the vapor pressure of the solvent is a predetermined level or more, a removal rate of the solvent becomes a predetermined level or more. As a result, when the coating solution for the lower layer includes the solvent as a solvent (dissolvent), the solvent-soluble polyimide is present in a dry state at a portion other than that in the vicinity of an interface of a lower layer coating film when applying the coating solution for the upper layer. Further, when the coating solution for the upper layer includes the solvent as the solvent (dissolvent), dissolution of a portion other than the vicinity of the air interface of the lower layer coating film by the solvent of the coating solution for the upper layer is suppressed. Here, the mixing of the upper layer and the lower layer as a whole is suppressed, and thus the composition in a surface of each layer is maintained uniformly, and a difference in the composition of each layer is also maintained well, thereby improving the properties when used the tubular article. Further, when the vapor pressure of the solvent is a predetermined level or less, a removal rate of the solvent becomes a predetermined level or less. As a result, when the coating solution for the lower layer includes the solvent as a solvent (dissolvent), the solvent-soluble polyimide and the solvent are present in a solvation state only in the vicinity of the air interface of the lower layer coating film when the coating solution for the upper layer is coated. Further, when the coating solution for the upper layer includes the solvent as a solvent (dissolvent), the solvent of the coating solution for the upper layer dissolves only the vicinity of the air interface of the lower layer coating film. Here, in the vicinity of the interface between the upper layer and the lower layer, molecules of the solvent-soluble polyimide spread over both layers, and entanglement of the molecular chains between the solvent-soluble polyimide in the lower layer coating film and the solvent-soluble polyimide in the coating solution for the upper layer is promoted, thereby improving peeling durability. When both of the coating solution for the upper layer and the coating solution for the lower layer include the solvents as solvents (dissolvents), since an appropriate time is required to remove the solvent from the coating film, leveling property is improved, and thus a film thickness of each layer becomes more uniform, thereby resulting in improvement of the peeling durability and properties when being used.

Further, the above mechanism is based on speculation, and right and wrong mechanisms do not affect the technical scope of the present invention.

In the present specification, the “polyimide resin layer” refers to a layer containing polyimide as a main component, and the “layer containing polyimide as a main component” refers to a layer in which the total mass of the polyimide exceeds 50% by mass (upper limit: 100% by mass) with respect to the total mass of the layer.

In addition, the polyimide resin layer preferably has a polyimide content of 60% by mass or more, more preferably 70% by mass or more, and further preferably 80% by mass or more with respect to the total mass of the layer from the viewpoint that better effects of the present invention are shown.

<Preparation of Coating Solution for Forming Polyimide Resin Layer>

In an embodiment of the present invention, at least two coating solutions for forming a polyimide resin layer (hereinafter, simply referred to as “coating solution”) each including: a solvent-soluble polyimide; and a solvent having a vapor pressure at 25° C. of 10 kPa or more and 19 kPa or less are prepared and used. As a method for preparing a coating solution, a commercially available product may be used, or a step for preparing the coating solution before the coating step may be prepared.

The method for preparing the coating solution is not particularly limited as long as it is capable of mixing the solvent-soluble polyimide and the solvent having a vapor pressure at 25° C. of 10 kPa or more and 19 kPa or less, and a known method can be used. When mixing the solvent-soluble polyimide and any other additive components, simple substances thereof may be used and solutions or dispersions thereof may be used. The addition order of these components and optionally used solvents is not particularly limited. In addition, methods and conditions of addition and mixing are not particularly limited.

An amount of the solvent-soluble polyimide added in the coating solution is not particularly limited, but is preferably 1 part by mass or more and 50 parts by mass or less, more preferably 5 parts by mass or more and 30 parts by mass or less, and further preferably 10 parts by mass or less and 20 parts by mass or less with respect to 100 parts by mass of the solvent. Within the above range, it is possible to obtain a viscosity capable of performing the coating better.

The mixing method is not particularly limited, but for example, may include mixing with a dissolver type stirrer.

Further, it is preferable that the coating solution is defoamed with a rotation and revolution type mixer, or the like.

(Polyimide-Based Component)

In the present specification, the “polyimide-based component” refers to a solvent-soluble polyimide, a polyimide other than the solvent-soluble polyimide, or a polyimide precursor.

[Solvent-Soluble Polyimide]

In an embodiment of the present invention, the coating solution for forming a polyimide resin layer includes a solvent-soluble polyimide.

By using the solvent-soluble polyimide, it is easy to select a solvent other than amide-based solvents having a low vapor pressure, thereby making it possible to improve peeling durability of a tubular article to be produced therefrom and properties thereof at the time of use. In addition, by using the solvent-soluble polyimide, firing treatment essential for the polyimide precursor is not necessary, and thus the number of steps can be reduced, thereby making it possible to improve productivity.

In the present specification, the term “solvent-soluble polyimide” means a polyimide dissolved in a solvent used when forming a coating solution, and solubility thereof is not particularly limited, but is preferably 10 parts by mass or more and 100 parts by mass or less with respect to 100 parts by mass of the solvent.

The solvent-soluble polyimide is not particularly limited as long as it is dissolved in a solvent having a vapor pressure at 25° C. of 10 kPa or more and 19 kPa or less, and a known polyimide can be used. For example, the solvent-soluble polyimide is preferably a material capable of lowering structural symmetry of a polymer molecule by introducing a substituent, in which a bending structure, such as an ether group, a thioether group, a carbonyl group, a bisphenol A structure, a fluorene structure, or the like, or a partial structure derived from 2,3,3′,4′-oxydiphthalic anhydride or the like, is large, into a molecular structure of a raw material monomer and a polymer skeleton after polymerization, thereby being dissolved in a solvent even though polyimidization is performed. Since the solvent-soluble polyimide is already imidized, the polyimide resin layer can be formed only by applying the coating solution and then removing the solvent.

Examples of preferred solvent-soluble polyimides may include, but are not particularly limited to, those having a structural unit (repeating unit) represented by Chemical Formula (1).

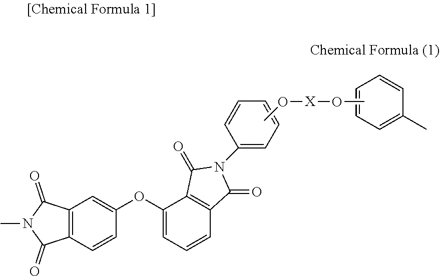

In Chemical Formula (1), X represents a divalent group having 7 or more and 25 or less carbon atoms. The number of carbon atoms included in X is preferably 12 or more and 19 or less.

In addition, on both ends of the above Chemical Formula (1), an atomic bond (straight line) in which nothing is bonded on one side indicates an atomic bond with the same structural unit or another structural unit. Further, the atomic bond of oxygen atoms with a benzene ring adjacent thereto on both sides of X indicates a bond to any one carbon of the benzene ring, and a position of two substituents (bonds) in these benzene rings means any one of an ortho position, a meta position, or a para position.

In addition, “polyimide” is a generic name of a polymer including an imide bond in a structural unit (repeating unit), but a specific polyimide including the structural unit represented by Chemical Formula (1) above is an aromatic polyimide in which an aromatic compound is directly connected by an imide bond.

In addition, from the viewpoint of solubility with respect to a solvent, X in Chemical Formula (1) is preferably a divalent group preferably including 2 or more and 4 or less phenylene groups, and more preferably 2 or more and 3 or less phenylene groups. In addition, the “divalent group including 2 or more phenylene groups” may include a divalent group represented by Chemical Formula (2) described below and may further include a divalent group an at least one side of both end sides (the opposite side of Y) of the two phenylene groups of Chemical Formula (2).

X in Chemical Formula (1) is preferably a divalent group represented by Chemical Formula (2) below.

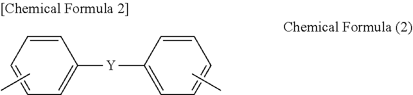

In Chemical Formula (2), Y represents a divalent group or a single bond. In addition, when Y is a single bond, the divalent group represented by Chemical Formula (2) is a biphenylene group. In the present specification, the biphenylene group and the like are also included in the “divalent group including two or more phenylene groups”.

In Chemical Formula (2), Y preferably includes at least one group selected from the group consisting of an alkylene group having 2 to 4 carbon atoms that may have a branch group, an oxylene group, a phenylene group that may have a substituent, a carbonyl group, and a sulfonyl group.

In Chemical Formula (2), examples of Y may include a divalent group represented by Chemical Formulas (3) to (7) below, or a group further including a divalent group on at least one side of both end sides of these groups.

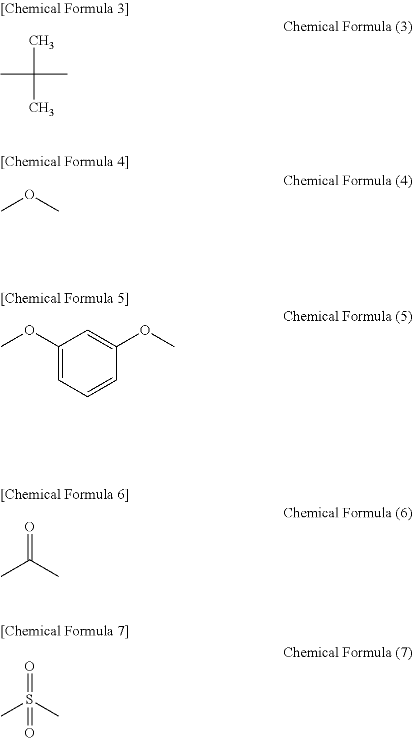

A specific polyimide including the structural unit represented by Chemical Formula (1) above may be synthesized from 2,3,3′,4′-oxydiphthalic anhydride represented by Chemical Formula (8) with dioxydianiline represented by Chemical Formula (9).

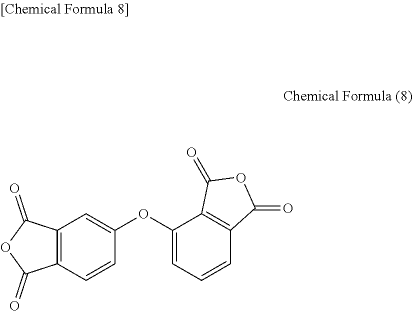

[Chemical Formula 9]

NH₂—Ar—O—X—O—Ar—NH₂ Chemical Formula (9)

In Chemical Formula (9), Ar represents a phenylene group, and X represents a divalent group having 7 or more and 25 or less carbon atoms and preferably a divalent group having 12 or more and 19 or less carbon atoms.

X is not particularly limited, but is preferably a group represented by Chemical Formula (10) below:

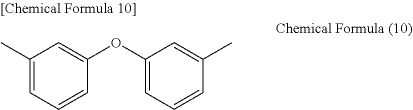

As a method for synthesizing a specific polyimide having a structural unit represented by Chemical Formula (1) above, conventionally known methods can be employed without particular limitation, and for example, may include a synthesis method using a chemical imidization reaction or a thermal imidization reaction described in JP 5495464 B2, or the like.

In addition, the solvent-soluble polyimide is not limited to a polyimide including only the structural unit represented by Chemical Formula (1), but may be a copolymer including other structural units. In the case of the copolymer, a ratio of the structural unit represented by Chemical Formula (1) to the whole polymer is preferably 80% by mass or more.

When the solvent-soluble polyimide includes other structural units, examples of the other structural units may include structural units derived from (meth)acrylic acid derivatives, aromatic vinyl monomers, olefinic hydrocarbon monomers, vinyl ester monomers, vinyl halide monomers, vinyl ether monomers, and the like. Further, these other structural units thereof may be used alone or in combination of two or more kinds thereof.

Further, as the solvent-soluble polyimide, for example, a solvent-soluble polyimide being dissolved in a solvent having a vapor pressure at 25° C. of 10 kPa or more and 19 kPa or less may be appropriately selected and used among known solvent-soluble polyimides described in paragraphs “0007” and “0008” of JP 2003-215827 A, paragraphs “0032” to “0040” of JP 2006-215076 A, paragraphs “0169” to “0349” of JP 2017-187562 A, paragraphs “0181” to “0360” of JP 2017-187617 A, and the like.

The solvent-soluble polyimide has a number average molecular weight of preferably 5,000 or more and 100,000 or less, more preferably 8,000 or more and 50,000 or less, and further preferably 10,000 or more and 40,000 or less.

In addition, the number average molecular weight of the solvent-soluble polyimide is preferably 10,000 or more and 100,000 or less, more preferably 20,000 or more and 70,000 or less, and further preferably 30,000 or more and 50,000 or less. When the weight average molecular weight is the lower limit value or more, mechanical strength of the tubular article to be produced is further improved. Further, when the weight average molecular weight is the upper limit or less, solubility with respect to the solvent having a vapor pressure at 25° C. of 10 kPa or more and 19 kPa or less is further improved.

The number average molecular weight and the weight average molecular weight of the polyimide-based component including the solvent-soluble polyimide may be measured by gel permeation chromatography (GPC) using polystyrene as a standard material, or the like. More specifically, the number average molecular weight and the weight average molecular weight thereof can be measured by the following measuring apparatus and measuring conditions.

[Expression 1]

GPC machine: TOSOH Corporation

### Model: HLC-8320GPC

### Solvent: 10 mM LiBr, 20 mM H3PO4 in DMF

Column: TSKgel SuperAWM-H×2 (6.0 mm I.D.×15 cm×2)
Flow rate: 0.6 mL/min
Sample concentration: 0.5 g/L (Polymer component concentration)
Injection amount: 20 μL
Column temperature: 40° C.
Detector: HLC-8320GPC Built-in RI detector/UV-8320 (Detected by UV: λ (280 nm))
Molecular weight markers: Standard polystyrene

These solvent-soluble polyimides may be used alone or in combination of two or more kinds thereof.

[Other Polyimide-Based Components]

In an embodiment of the present invention, a polyimide or a polyimide precursor other than the above-described solvent-soluble polyimide may be included. However, in an embodiment of the present invention, it is preferable that the coating solution does not substantially include other polyimide-based components, particularly, a polyimide precursor. In the present specification, the phrase “does not substantially include other polyimide-based components” means that the other polyimide-based components are included in an amount of 0.1 parts by mass or less and preferably 0.01 parts by mass or less with respect to 100 parts by mass of the total mass of the polyimide-based component, and further preferably, that the other polyimide-based components are not included at all (0 part by mass).

(Conductive Agent)

In an embodiment of the present invention, at least one of the coating solutions may further include a conductive agent. The conductive agent has a function of dispersing in the polyimide and adjusting electric resistance of a tubular article (for example, a seamless belt).

The conductive agent is not particularly limited, and a known conductive agent can be used. Among them, carbon nanofibers (CNF), metal oxides, and carbon black are preferable.

The carbon nanofiber (CNF) is not particularly limited, but is preferably has an average fiber diameter of 10 nm or more and 45 nm or less, and more preferably has an average fiber diameter of 10 nm or more and 20 nm or less. Further, it is preferable to have an extremely high aspect ratio. When the average fiber diameter of the carbon nanofiber is the lower limit value or more, a cohesive force among the fibers is lowered, and thus the carbon nanofiber can be sufficiently dispersed in a resin matrix. Further, when the average fiber diameter of the carbon nanofiber is the above upper limit value or less, an added amount for obtaining desired conductivity becomes small, and thus mechanical properties such as tensile fracture elongation become better. In addition, the average fiber diameter can be measured by a photographic image such as a scanning electron microscope (SEM) or a transmission electron microscope (TEM). The carbon nanofibers can be produced according to a conventionally known production method, and examples thereof may include a vapor phase growth method, a melt spinning method, or the like.

The metal oxide is not particularly limited, but examples thereof may include zinc oxide, tin oxide, titanium oxide, zirconium oxide, aluminum oxide, silicon oxide, and the like. In addition, in order to improve dispersibility, the metal oxide may be subjected to a surface treatment in advance.

The carbon black is not particularly limited, but examples thereof may include Ketjen Black (registered trademark), furnace black, acetylene black, thermal black, gas black, and the like.

Among these conductive agents, carbon nanofibers or carbon black is preferable, and the carbon black is more preferable.

As the conductive agent, a commercially available product may be used. The commercially available product is not particularly limited, but for example, may include SPECIAL BLACK 4 manufactured by Degussa, and the like.

These conductive agents can be used alone or in combination of two or more kinds thereof.

An added amount of the conductive agent is not particularly limited, but is preferably 0.1 parts by mass or more and 30 parts by mass or less, more preferably 1 part by mass or more and 30 parts by mass or less, and further preferably 10 parts by mass or more and 30 parts by mass or less with respect to 100 parts by mass of the resin component (polyimide-based component, and other polymeric additive components that may optionally be included). When the added amount of the conductive agent is the lower limit value or more, formation of an electrical conduction path becomes better, and thus conductivity becomes better. From this, the conductivity is further improved when the properties of a tubular article to be produced at the time of use are conductive. When the added amount of the conductive agent is the upper limit value or less, mechanical properties such as tensile fracture elongation of the tubular article to be produced, are maintained better.

Here, the added amount of the conductive agent of the coating solution for forming the polyimide resin layer disposed on the outermost peripheral side is preferably smaller than an added amount of that in other layers, and is particularly preferably 10 parts by mass or more and 15 parts by mass or less with respect to 100 parts by mass of the resin component (polyimide-based component, and other polymeric additive components that may optionally be included). Further, the added amount of the conductive agent in the coating solution that forms the other polyimide resin layer is particularly preferably 20 parts by mass or more and 30 parts by mass or less.

(Other Additive Components)

In an embodiment of the present invention, to at least one of the coating solutions may be added other additive components such as an antioxidant, a filler, a lubricant, a dye, an organic pigment, an inorganic pigment, a plasticizer, a leveling agent, or a processing aid such as an acrylic processing aid, an ultraviolet absorber, a light stabilizer, a foaming agent, a wax, a crystal nucleating agent, a release agent, a hydrolysis inhibitor, an antiblocking agent, an antistatic agent, a radical scavenger, an antifogging agent, an antifungal agent, an ion trapping agent, a flame retardant, a flame retardant aid, and the like, within an appropriate range in which effects of the present invention are not impaired.

(Solvent)

[Solvent Having a Vapor Pressure at 25° C. of 10 kPa or More and 19 kPa or Less]

In an embodiment of the present invention, the coating solution for forming a polyimide resin layer includes a solvent having a vapor pressure at 25° C. of 10 kPa or more and 19 kPa or less.

When the vapor pressure at 25° C. is less than 10 kPa, the properties of the tubular article to be produced at the time of use are deteriorated. In addition, if it is attempted to form each layer with a desired composition, heating and drying is required after the lower layer coating film is formed, and thus productivity is deteriorated. Further, when the vapor pressure at 25° C. exceeds 19 kPa, the peeling durability of the tubular article to be produced and the properties thereof at the time of use are deteriorated. Accordingly, by using the solvents in which a vapor pressure at 25° C. is within a predetermined range as the coating solutions for an upper layer and a lower layer, it is possible to improve the peeling durability of the tubular article to be produced and the properties thereof at the time of use.

From the same viewpoint, the vapor pressure at 25° C. is more preferably 10 kPa or more and 15 kPa or less, further preferably 10 kPa or more and 13 kPa or less, and particularly preferably 10 kPa or more and 11 kPa or less.

The vapor pressure at 25° C. can be measured by a known method such as a gas flow method or a stationary method in consideration of the vapor pressure of the solvent, and can be measured by adopting the stationary method if the vapor pressure can be accurately measured by the stationary method.

In addition, the reason that the vapor pressure at 25° C. is selected in the present invention is a matter in consideration of removability of the solvent in the vicinity of room temperature so that the solvent can be removed from the lower layer coating film without substantially heating and drying after the lower layer coating film is formed.

The solvents having a vapor pressure at 25° C. of 10 kPa or more and 19 kPa or less are not particularly limited, but may include, as preferable examples, tetrahydrofuran (THF) (18.9 kPa), 1,2-dichloroethane (11.6 kPa), cyclohexane (10.3 kPa), and the like. Among them, the cyclohexane is particularly preferable.

These solvents having a vapor pressure of 10 kPa or more and 19 kPa or less at 25° C. can be used alone or in combination of two or more kinds thereof.

A content ratio of the solvent having a vapor pressure at 25° C. of 10 kPa or more and 19 kPa or less is preferably 70% by mass or more and 100% by mass or less, more preferably 70% by mass or more and less than 100% by mass, further preferably 80% by mass or more and 99% by mass or less, and particularly preferably 85% by mass or more and 95% by mass or less, with respect to the total mass of the solvent. When the content ratio is the lower limit value or more, the productivity, the peeling durability of the tubular article to be produced and the properties thereof at the time of use are further improved. In addition, when the content ratio is the upper limit value or less, the peeling durability of the tubular article to be produced and the properties thereof at the time of use are further improved.

[Other Solvents]

In an embodiment of the present invention, the solvent may further include a solvent having a vapor pressure at 25° C. of less than 10 kPa, or a solvent having a vapor pressure at 25° C. of more than 19 kPa. In addition, a method for measuring these vapor pressures is also the same as that in the case of the solvent having a vapor pressure at 25° C. of 10 kPa or more and 19 kPa or less described above.

Among them, a solvent having a vapor pressure at 25° C. of 0.1 kPa or more and less than 10 kPa is preferable, a solvent having a vapor pressure at 25° C. of 0.1 kPa or more and 5 kPa or less is more preferable, a solvent having a vapor pressure at 25° C. of 0.1 kPa or more and 3 kPa or less is further preferable, and a solvent having a vapor pressure at 25° C. of 0.1 kPa or more and 1 kPa or less is particularly preferable. When the vapor pressure is the lower limit value or more, a decrease in productivity due to the addition of the solvent is further suppressed, and thus good productivity which is an effect of the present invention is more reliably maintained. When the vapor pressure is the upper limit value or less, the peeling durability of the tubular article to be produced and the properties thereof at the time of use are further improved.

The reason that the above effect is obtainable without impairing the effect of the present invention by adding the solvent is presumed as follows, although the details are unknown. It is presumed because the solvent is present on a part of a surface of the coating film during drying, and thus drying of the solvent is appropriately suppressed, spreading and entanglement of molecules is promoted only in the vicinity of the interface between the upper layer and the lower layer, and leveling tends to proceed more easily. However, the above mechanism is based on speculation, and right and wrong mechanisms do not affect the technical scope of the present invention.

The solvent having a vapor pressure at 25° C. of 0.1 kPa or more and less than 10 kPa is not particularly limited, but may include cyclohexanone (0.5 kPa), 3-pentanone (2.7 kPa), toluene (3.8 kPa), and the like. Among them, the cyclohexanone is particularly preferable.

A mass proportion of the solvent having a vapor pressure at 25° C. of 0.1 kPa or more and less than 10 kPa with respect to the total mass of a solvent having a vapor pressure at 25° C. of 10 kPa or more and 19 kPa or less and a solvent having a vapor pressure at 25° C. of 0.1 kPa or more and less than 10 kPa is preferably more than 0% by mass and 30% by mass or less, more preferably 1% by mass or more and 20% by mass or less, further preferably 5% by mass or more and 15% by mass or less, and particularly preferably 10% by mass.

These other solvents may be used alone or in combination of two or more kinds thereof.

<Coating Step>

A method for producing a tubular article according to an embodiment of the present invention includes continuously coating at least two coating solutions for forming a polyimide resin layer to form a stacked coating film. That is, a method for producing a tubular article according to an embodiment of the present invention includes a coating step of continuously coating at least two coating solutions for forming a polyimide resin layer to form a stacked coating film. More specifically, the coating step is a coating step of forming a stacked coating film by coating one (coating solution for lower layer) of the at least two coating solutions for forming a polyimide resin layer to form a coating film (lower layer coating film), and then continuously coating the other one (coating solution for upper layer) of the at least two coating solutions for forming a polyimide resin layer on the coating film. Further, the stacked coating film formed in the coating step includes a constitution of three or more stacked coating film which is constituted by coating the coating solution for the lower layer to form a lower layer coating film, continuously coating the coating solution for the upper layer on the coating film to form a stacked coating film, and then repeating the coating of the coating solution for the upper layer continuously using the upper layer coating film in the stacked coating film as a lower layer coating film at an arbitrary number of times.

As described above, “continuously coating” means that the coating solution for each layer is sequentially applied without substantially performing heat treatment such as heating and drying or heating and firing during a period from the formation of the lower layer coating film to the coating of the coating solution for the upper layer on the surface of the lower layer coating film. In addition, “heat treatment such as heating and drying or heating and firing is not substantially performed” means that heating is not actively performed.

In the coating step, on a coated support such as a mold, the lowermost layer (i.e., a polyimide resin layer which is formed at a position nearest to the coated support such as a mold and which is positioned at the innermost peripheral side or the outermost peripheral side in the polyimide resin layer of the tubular article to be produced) is formed, and a coating film of the second layer from the bottom is formed on a surface of the coating film of the lowermost layer without substantially performing heat treatment such as heating and drying or heating and firing and if necessary, in order to form an additional layer, the same operation as the formation of the coating film of the second layer is repeated without substantially performing heat treatment such as heating and drying or heating and firing.

By using the solvent including the solvent having a vapor pressure at 25° C. of 10 kPa or more and 19 kPa or less, the solvent can be removed from the lower layer coating film without substantially heating and drying after the lower layer coating film is formed. Thereby, the heating treatment is not necessary during a period from the formation of the lower layer coating film to the coating of the coating solution for the upper layer on the surface of the lower layer coating film, thereby making it possible to improve productivity.

Here, a temperature at the time of coating a coating solution for forming each layer is not particularly limited, but is preferably 22° C. or more and 25° C. or less, and a relative humidity at the time of coating is preferably 40% RH or more and 50% RH or less. Within the above range, the productivity, the peeling durability of the tubular article to be produced, and the properties thereof at the time of use are further improved.

Further, the environment during a period from the formation of the lower layer coating film to the coating of the coating solution for the upper layer on the surface of the lower layer coating film is not particularly limited if beating is not actively performed, but the temperature is preferably within the range of ±5° C., more preferably within the range of ±2° C. from the time of coating the lower layer, and further preferably, the same temperature as the time of coating the lower layer. The relative humidity is preferably in the range of ±10% RH, more preferably in the range of ±5% RH from the time of coating the lower layer, and further preferably, the same relative humidity as the time of coating the lower layer. As specific examples of preferable conditions, the temperature is preferably 22° C. or more and 25° C. or less, and the relative humidity is preferably 40% RH or more and 50% RH or less.

An interval from the formation of the lower layer coating film to the coating of the coating solution for the upper layer on the surface of the lower layer coating film is not particularly limited, but is preferably 10 seconds or more and 3 minutes or less, more preferably 30 seconds or more and 2 minutes or less, and further preferably 45 seconds or more and 1 minute and 30 seconds or less. Within the above range, the productivity, the peeling durability of the tubular article to be produced and the properties thereof at the time of use are further improved.

When the interval is the lower limit or more, the removal of the solvent in the lower layer coating film can be further advanced, and the properties of the tubular article to be produced at the time of use are further improved. In addition, when the interval is the upper limit or less, a residual solvent amount of the lower layer coating film can further increase within an appropriate range in the present invention, and thus interlayer adhesiveness of the tubular article to be produced and the properties thereof at the time of use are further improved.

The coating method is not particularly limited, and a known method can be used. Among them, a method for coating a coating solution to the entire inner peripheral surface or the entire outer peripheral surface using a discharge member such as dice, a nozzle, a needle, a spray, or a solution supply device such as a dispenser may be included. Among them, a method of coating using dice or a dispenser is preferable, and a method of coating using a dispenser is more preferable.

A moving speed of the discharge member or a discharge part of the solution supply device is not particularly limited, but it is preferably 0.01 mm/sec or more and 100 mm/sec or less, more preferably 0.02 mm/sec or more and 50 mm/sec or less, and further preferably 0.1 mm/sec or more and 10 mm/sec or less.

A feeding amount of the coating solution is not particularly limited, but is preferably 1 mL/min or more and 1,000 mL/min or less, more preferably 5 mL/min or more and 200 mL/min or less, and further preferably 10 mL/min or more and 100 mL/min or less.

In the case where the discharge member or the discharge part of the solution supply device is a nozzle, an inner diameter φ of the nozzle is not particularly limited, but is preferably 0.01 mm or more and 10 mm or less, more preferably 0.2 mm or more and 5 mm or less, and further preferably 0.5 mm or more and 2 mm or less.

For the coating condition of the coating solution for forming the polyimide resin layer disposed on the outermost peripheral side of the tubular article to be produced, a dried film thickness is preferably 10 μm or more and 160 μm or less, more preferably 15 μm or more and 80 μm or less, and further preferably, 30 μm or more and 40 μm or less.

For the coating condition of the coating solution for forming the other polyimide resin layer of the tubular article to be produced, a dried film thickness is preferably 10 μm or more and 200 μm or less, more preferably 20 μm or more and 100 μm or less, and further preferably, 40 μm or more and 50 μm or less.

The method for producing a tubular article according to an embodiment of the present invention, the coating step includes forming the stacked coating film on an inner peripheral surface or an outer peripheral surface of a cylindrical mold, and preferably further includes a heating and drying step of heating the stacked coating film to form a dried coating film after the coating step and a mold separating step of separating the heated and dried coating film from the cylindrical mold.

In the case of forming a tubular article from a planar multilayer laminate, it is difficult to heat and melt the polyimide resin, and thus it is common to form a tubular article by overlapping and bonding both ends of the multilayer laminate using an adhesive, and in this case, discontinuous junctions occur. However, by using the cylindrical mold, the discontinuous junctions can be eliminated, and the properties of the tubular article to be produced at the time of use are further improved. Further, a joining step is not required, and thus the productivity is further improved. In other words, in the production method according to an embodiment of the present invention, the tubular article to be produced is preferably a seamless tubular article (for example, a seamless belt or the like).

In the case of using the cylindrical mold, in forming the coating film, it is preferable to continuously supply the coating solution by the discharge member while rotating the cylindrical mold, and to move the discharge member in a direction of a rotation axis of the cylindrical mold so that the coating solution is spirally coated to form the coating film.

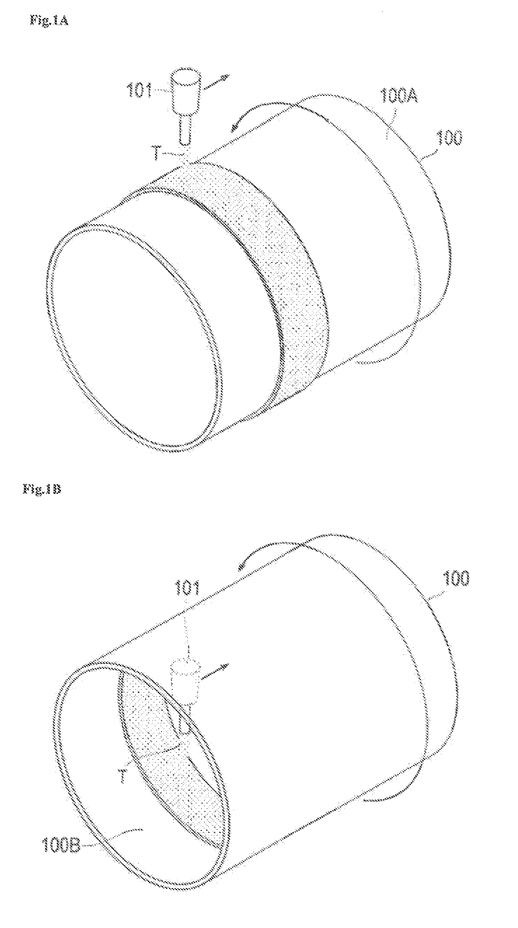

FIGS. 1A and 1B are schematic views showing an example of a coating method. FIG. 1A is a schematic view when a coating film is formed on an outer peripheral surface 100A of a cylindrical mold 100, and FIG. 1B is a schematic view when the coating film is formed on an inner peripheral surface 100B of the cylindrical mold 100. In forming the coating film, while rotating the cylindrical mold 100 at a predetermined speed, a coating solution T is uniformly coated onto the entire outer peripheral surface 100A or the entire inner peripheral surface 100B of the cylindrical mold 100 using a discharge member or the discharge part 101, or the like.

In addition, even though the formation of the lowermost layer is taken as an example in FIG. 1, an upper coating film is formed by being coated in the same manner as above except that a coating solution for the upper layer is coated on a surface of the already formed lower layer coating film.

In the case of using the cylindrical mold, it is preferable to form the coating film on the outer peripheral surface of the cylindrical mold.

A peripheral speed of the cylindrical mold at the time of coating is not particularly limited, but is preferably 500 mm/sec or more and 1,200 mm/sec or less.

Further, in order to make the coating film uniform, after coating, spreading the coating film by rotating the cylindrical mold at a higher speed than that of the coating may be further performed.

The cylindrical mold is not particularly limited, and a known cylindrical mold can be used. When the coating solution is coated to the inner peripheral surface of the cylindrical mold, the mold is required to be hollow cylindrical, but when the coating solution is coated to the outer peripheral surface of the cylindrical mold, the mold may be or may not be hollow cylindrical.

A material of the cylindrical mold is not particularly limited, and known materials can be used. Examples of the material thereof may include carbon steel, stainless steel, aluminum, iron, and the like. Among them, stainless steel is preferable. Examples of preferable types of stainless steel may include austenitic stainless steel such as SUS304, SUS316.

In the case of coating on the outer peripheral surface of the cylindrical mold, an outer diameter of the cylindrical mold may be appropriately selected according to a desired size of the tubular article, and is not particularly limited. However, the outer diameter of the cylindrical mold (a diameter of the coated surface of the cylindrical mold) is preferably 100 mm or more and 1,000 mm or less, more preferably 200 mm or more and 900 mm or less, and further preferably 240 mm or more and 800 mm or less from the viewpoint of production efficiency and a reduction in temperature distribution in a heating and drying step to be described below.

In the case of coating on the inner peripheral surface of the cylindrical mold, the inner diameter of the cylindrical mold may be appropriately selected according to the desired size of the tubular article, and is not particularly limited. However, the inner diameter of the cylindrical mold (a diameter of the coated surface of the cylindrical mold) is preferably 100 mm or more and 1,000 mm or less, more preferably 200 mm or more and 900 mm or less, and further preferably 240 mm or more and 800 mm or less from the viewpoint of production efficiency and reduction in temperature distribution in a heating and drying step to be described below.

A width (a length in a rotation axis direction) of the cylindrical mold may be appropriately selected according to the desired size of the tubular article, and is not particularly limited. However, the width of the cylindrical mold is preferably 200 mm or more and 2,000 mm or less, more preferably 250 mm or more and 1,500 mm or less, and further preferably 300 mm or more and 1,000 mm or less, from the viewpoint of production efficiency or reduction in temperature distribution in a heating and drying step to be described below.

It is preferable to apply a releasing agent in advance to a surface of the cylindrical mold in which the coating film is to be formed so that the coating film is easily separated from the mold.

<Heating and Drying Step>

It is preferable that the method for producing a tubular article according to an embodiment of the present invention further includes heating the stacked coating film to form a dried coating film after the coating. That is, it is preferable that the method for producing a tubular article according to an embodiment of the present invention further includes a heating and drying step of heating the stacked coating film to form a dried coating film after the coating step.

The drying treatment of the coating film may be performed by a single drying treatment or by a plurality of drying treatments. When the plurality of drying treatments are performed, cooling may be included between the respective drying treatments.

The drying condition of the coating film is not particularly limited and known conditions can be used. An average temperature at the time of drying varies depending on the type of the coating solution, but is preferably 50° C. or more and 250° C. or less, more preferably 100° C. or more and 200° C. or less, and further preferably 100° C. or more and 150° C. or less.

Drying time of the coating film varies depending on the type of the coating solution, but is preferably 5 minutes or more and 180 minutes or less, more preferably 10 minutes or more and 90 minutes or less, and further preferably 10 minutes or more and 60 minutes or less in one drying treatment.

In the case of using the cylindrical mold in the coating step, in the heating and drying step, the drying may be performed in a state in which the cylindrical mold is rotated, or the drying may be performed after the rotation of the cylindrical mold is stopped. However, it is preferable to perform drying in the state in which the cylindrical mold is rotated and then to further perform drying after the rotation of the cylindrical mold is stopped.

Further, the heating means is not particularly limited, and a known heating means can be used.

<Mold Separating Step>

The method for producing a tubular article according to an embodiment of the present invention preferably further includes separating the dried coating film from the mold. That is, the method for producing a tubular article according to an embodiment of the present invention preferably further includes a mold separating step of separating the dried coating film from the mold.

In the mold separating step, it is preferable that the product (dried coating film) is cooled to room temperature and then the product is separated from a rotating body.

<Other Steps>

The production method according to an embodiment of the present invention may have other steps as long as effects of the present invention are not impaired. Other steps may include, but are not particularly limited to, a step for forming other layers that may be included in known tubular articles, and the like. The method for forming the other layers may be appropriately set so that desired characteristics can be obtained with respect to the kind, composition, and properties, and the like, within a range in which the effects of the present invention are not impaired. Further, the other steps may be performed before the coating step, between any of the above respective steps, or after the mold separating step.

<Tubular Article>

According to the method for producing a tubular article according to a preferred embodiment of the present invention, a multilayer tubular article is produced, the multilayer tubular article including a stacked structure in which at least two polyimide resin layers are stacked.

In the present specification, “the stacked structure in which at least two polyimide resin layers are stacked” means a stacked structure in which at least two polyimide resin layers are in contact with each other. Here, at the time of performing composition analysis or measurement of physical properties with respect to a film thickness direction, each layer can be classified by confirming the presence of a region in which the composition or the physical properties are clearly different. For example, when the multilayer tubular article includes a conductive agent, each layer can be classified by confirming the presence or absence of the conductive agent and the content of the conductive agent. Further, when the polyimide resin of each layer constituting the multilayer tubular article is different, each layer can be classified by confirming the composition of the polyimide resin.

As an example of the classification method of each layer, there is a method of cutting each multilayer tubular article in the film thickness direction, analyzing the cross section, and determining each layer (for example, upper layer and lower layer) by classification from a black density difference. In particular, when at least one layer of the multilayer tubular article includes the conductive agent, it is preferable that the presence or absence of the conductive agent and the difference of the added amount thereof in each layer is confirmed by observing the cross section by naked eyes.

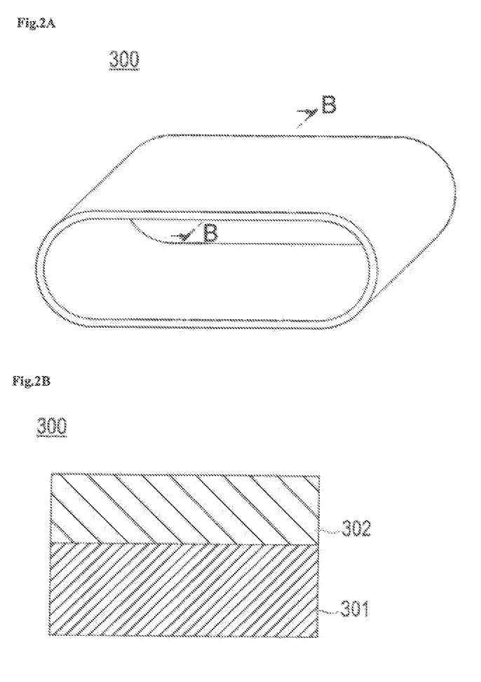

FIGS. 2A and 2B are schematic views showing a preferable example of a configuration of a multilayer tubular article to be produced, wherein FIG. 2A is a schematic view showing the whole of the multilayer tubular article, and FIG. 2B is a schematic cross-sectional view showing a stacked structure of the multilayer tubular article shown in FIG. 2A. Here, a multilayer tubular article 300 includes: a polyimide resin layer 302 disposed on the outermost peripheral side; and the other polyimide resin layer 301 (a polyimide resin layer other than the polyimide resin layer disposed on the outermost peripheral side).

The dried film thickness of the polyimide resin layer disposed on the outermost peripheral side is not particularly limited, but is preferably 10 μm or more and 200 μm or less, more preferably 20 μm or more and 100 μm or less, and further preferably 40 μm or more and 50 μm or less. Further, the dried film thickness of the other polyimide resin layer is not particularly limited, but is preferably 10 μm or more and 160 μm or less, more preferably 15 μm or more and 80 μm or less, and further preferably 30 μm or more and 40 μm or less. Further, the total dried film thickness of the multilayer tubular article is not particularly limited, but is preferably 20 μm or more and 360 μm or less, more preferably 35 μm or more and 180 μm or less, and further preferably 70 μm or more and 90 μm or less.

<Use>

(Intermediate Transfer Belt)

The use of the tubular article to be produced is not particularly limited, but is preferably used as an intermediate transfer belt. The tubular article to be produced can provide excellent image quality over a long period of time and may be preferably used as an intermediate transfer belt of an electrophotographic image forming apparatus such as a copying machine (including a color copying machine), a printer, or a facsimile.

(Image Forming Apparatus)

Hereinafter, an example in which a tubular article to be produced is used as an intermediate transfer belt of an electrophotographic image forming apparatus is described. However, the use of the tubular article produced by the production method according to an embodiment of the present invention is not limited thereto. In addition, the constitution of the electrophotographic image forming apparatus in which the tubular article is used is not limited thereto.

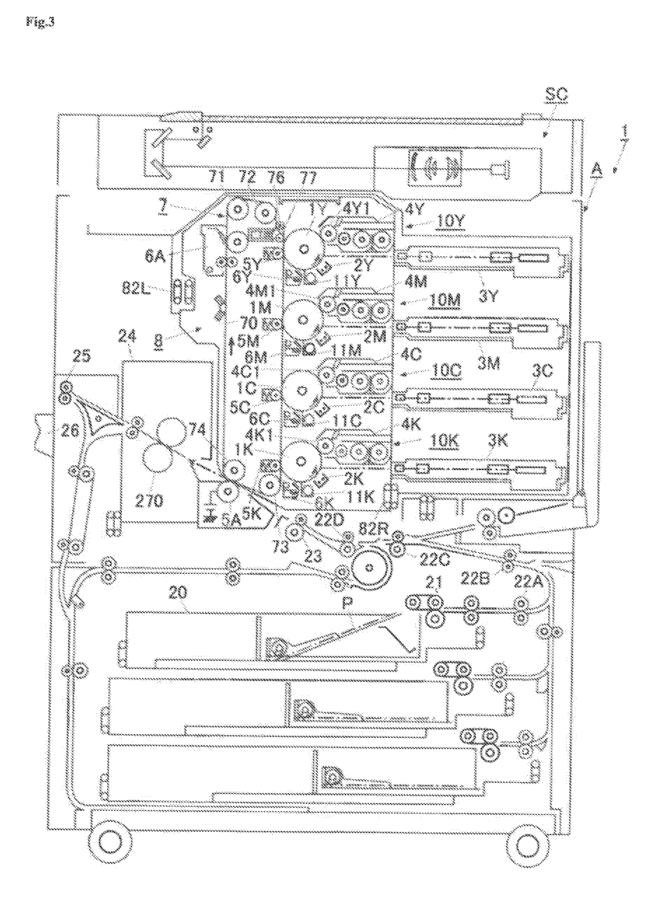

Hereinafter, an embodiment of the present invention is described with reference to FIG. 3 accompanying therewith. FIG. 3 is a schematic cross-sectional constitutional view showing an example of the image forming apparatus. In addition, in FIG. 3, a case of a full-color image forming apparatus is shown.

An image forming apparatus 1 includes a plurality of sets of image forming units 10Y, 10M, 10C, and 10K; a seamless belt-type intermediate transfer body forming unit 7 as a transfer part; a seamless belt-type paper feeding conveying means 21 that conveys a recording medium P; and a belt-type fixing device 24 as a fixing means. An original image reading device SC is disclosed in an upper part of a main body A of the image forming apparatus 1.

The image forming unit 10Y that forms a yellow image, as one of toner images having different colors formed on the respective photoreceptors 1Y, 1M, 1C, and 1K, has a drum-type photoreceptor 1Y as a first image carrier; a charging means 2Y arranged around the photoreceptor 1Y; an exposing means 3Y; a developing means 4Y having a developer carrier 4Y1; a primary transfer roller 5Y as a primary transfer means; and a cleaning means 6Y.

Further, the image forming unit 10M that forms a magenta color image, as one of toner images having different colors, has a drum-type photoreceptor 1M as a first image carrier; a charging means 2M arranged around the photoreceptor 1M; an exposing means 3M; a developing means 4M having a developer carrier 4M1; a primary transfer roller 5M as a primary transfer means; and a cleaning means 6M.

Further, the image forming unit 10C that forms a cyan color image, as one of toner images having different colors, has a drum-type photoreceptor 1C as a first image carrier; a charging means 2C arranged around the photoreceptor 1C; an exposing means 3C; a developing means 4C having a developer carrier 4C1; a primary transfer roller 5C as a primary transfer means; and a cleaning means 6C.

Further, the image forming unit 10K that forms a block color image, as one of toner images having different colors, has a drum-type photoreceptor 1K as a first image carrier; a charging means 2K arranged around the photoreceptor 1K; an exposing means 3K; a developing means 4K having a developer carrier 4K1: a primary transfer roller 5K as a primary transfer means; and a cleaning means 6K.

The seamless belt-type intermediate transfer body forming unit 7 has a seamless intermediate transfer belt 70 as a semiconductive endless belt-type second image carrier wound by a plurality of rollers and rotatably supported.

The images of the respective colors formed by the image forming units 10Y, 10M, 10C, and 10K are sequentially transferred onto the rotating seamless intermediate transfer belt 70 by the primary transfer rollers 5Y, 5M, 5C, and 5K, and thus a synthesized color image is formed.

The recording medium P, such as paper, contained in a paper feeding cassette 20 is fed by the paper feeding conveying means 21, and conveyed through a plurality of intermediate rollers 22A, 22B, 22C, and 22D and a resist roller 23 to a secondary transfer roller 5A as the secondary transfer means, and thus color images are collectively transferred onto the recording medium P.

The recording medium P to which the color image is transferred is subjected to fixing processing by a fixing device 24 equipped with a heat roller fixer 270, interposed into a paper ejecting roller 25, and placed on a paper ejecting tray 26 outside the device.

Meanwhile, after the color image is transferred to the recording medium P by the secondary transfer roller 5A, a residual toner in the seamless intermediate transfer belt 70 obtained by curvature separation of the recording medium P is removed by the cleaning means 6A.

During the image forming treatment, the primary transfer roller 5K is constantly in pressure-contact with the photoreceptor 1K. Other primary transfer rollers 5Y, 5M, and 5C are in pressure-contact with the corresponding photoreceptors 1Y, 1M, and 1C, respectively, only when color images are formed.

The secondary transfer roller 5A is in pressure-contact with the seamless intermediate transfer belt 70 only when the recording medium P passes through the secondary transfer roller 5A and the secondary transfer is performed.

Further, a case 8 can be withdrawn out from the apparatus main body A via support rails 82L and 82R. The case 8 includes image forming units 10Y, 10M, 10C, and 10K; and a seamless belt-type intermediate transfer body forming unit 7.

The image forming units 10Y, 10M, 10C, and 10K are vertically arranged in a column. On the left side of the shown photoreceptors 1Y, 1M, 1C, and 1K, the seamless belt-type intermediate transfer body forming unit 7 is disposed. The seamless belt-type intermediate transfer body forming unit 7 has a seamless intermediate transfer belt 70 which is rotatable by winding around rollers 71, 72, 73, 74, 76 and 77, primary transfer rollers 5Y, 5M, 5C, and 5K, and a clearing means 6A.

The image forming units 10Y, 10M, 10C, and 10K and the seamless belt-type intermediate transfer body forming unit 7 are united and withdrawn from the main body A by withdrawal operation of the case 8.

After a latent image is formed by charging and exposure on the outer peripheral surfaces of the photoreceptors 1Y, 1M, 1C, and 1K, the toner image (visible image) is formed by development, the toner image of each color is overlapped on the seamless intermediate transfer belt 70, transferred to the recording medium P at a time, and fixed by pressing and heating with the belt-type fixing device 24.

In the photoreceptors 1Y, 1M, 1C and 1K after transferring the toner image to the recording medium P, the toner remaining on the photoreceptor during the transferring is cleaned by the cleaning means 6Y, 6M, 6C and 6K installed in the respective photoreceptors 1Y, 1M, 1C and 1K, and then the obtained mixture enters a cycle of charging, exposure, and development to perform subsequent image formation.

In the image forming apparatus 1, an elastic blade is used as a cleaning member of the cleaning means 6A for cleaning the intermediate transfer belt 70. In addition, means (11Y, 11M, 11C, and 11K) for applying a fatty acid metal salt to each photoreceptor are provided.

The present invention includes the following embodiments and forms.

1. A method for producing a tubular article including:
continuously coating at least two coating solutions for forming a polyimide resin layer to form a stacked coating film, the two coating solutions each including a solvent-soluble polyimide; and a solvent having a vapor pressure of 10 kPa or more and 19 kPa or less at 25° C.
2. The method for producing a tubular article according to the above 1, the coating includes forming the stacked coating film on an inner peripheral surface or an outer peripheral surface of a cylindrical mold, the method, further including, after the coating,

heating the stacked coating film to form a dried coating film after the coating; and

separating the heated and dried coating film from the cylindrical mold.

3. The method for producing a tubular article according to the above 1 or 2, wherein in the coating, the at least two coating solutions for forming a polyimide resin layer are coated using dice or a dispenser.
4. The method for producing a tubular article according to any one of the above 1 to 3, wherein at least one of the at least two coating solutions for forming a polyimide resin layer further includes a conductive agent.
5. The method for producing a tubular article according to any one of the above 1 to 4, wherein the solvent-soluble polyimide has a constituent unit represented by Chemical Formula (1) below:

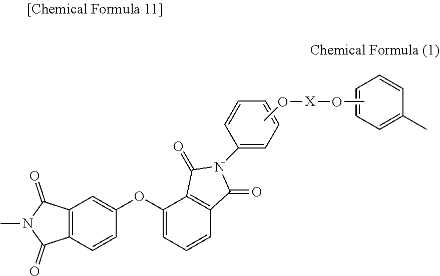

in Chemical Formula (1), X represents a divalent group having 7 or more and 25 or less carbon atoms.
6. The method for producing a tubular article according to any one of the above 1 to 5, wherein the tubular article is an intermediate transfer belt.

Although the embodiments of the present invention have been described above in detail, the embodiments of the present invention are not limited to the above example, and various modifications can be added.

### Example

The effects of the present invention are described using the following Examples and Comparative Examples.

In the following Examples, “parts” and “%” mean “parts by mass” and “% by mass”, respectively, unless otherwise specified. In addition, the present invention is not limited to Examples below.

<Production of Tubular Article>

(Production of Multilayer Tubular Article 1)

[Synthesis of Solvent-Soluble Polyimide (Soluble PI) Powder]

In a 5,000 mL round-bottomed four-necked flask equipped with a mechanical shaker, a thermometer and a nitrogen gas inlet tube, 310 g (1 mol) of 2,3,3′,4′-oxydiphthalic anhydride, 200 g of dioxydianiline in which X in Chemical Formula (9) above is a divalent group represented by Chemical Formula (10) above, and 2,200 mL of dimethylacetamide (DMAc) were charged and reacted for 4 hours to prepare a polyimide acid solution. Next, 1,050 g of acetic anhydride. 260 g of triethylamine as a catalyst, and 220 g of toluene were added and reacted for 1 hour to complete imidation, and the polyimide powder was filtered off. Subsequently, the powder was washed three times with 1,000 mL of acetone, filtered, and dried for 2 hours, followed by heat treatment at 220° C. or more and 280° C. or less for 2 hours or more and 5 hours or less to prepare 426.6 g of powder of polyimide P which is a solvent-soluble polyimide. In addition, a molecular weight of the obtained polyimide P powder was measured. As a result, the number average molecular weight (Mn) was 33,000 and the weight average molecular weight (Mw) was 65,000.

[Preparation of Coating Solution for Lower Layer]

A THF solution containing 150 g of polyimide P was prepared by dissolving 150 g of the obtained polyimide P powder in 1,000 g of THE which is a protonic polar solvent. To the THF solution in which the polyimide P was dissolved, 30 g of carbon black (CB) SPECIAL BLACK 4 (manufactured by Degussa, pH 4.0) was further added, treated with a ball mill for 6 hours, and then filtered to obtain a polyimide P solution in which carbon black was dispersed. This solution was used as a coating solution for a lower layer.

[Preparation of Coating Solution for Upper Layer]

A polyimide P solution in which carbon black was dispersed was obtained in the same manner as in the coating solution for the lower layer except that the added amount of carbon black was changed to 15 g. This solution was used as a coating solution for an upper layer.

[Costing Step: Continuous Coating]

A cylindrical mold having an outer diameter (diameter of the coated surface of the cylindrical mold) of 240 mm and a length of 450 mm was set in a coating apparatus and then rotated at a peripheral speed of 500 mm/sec. Further, the coating solution for the lower layer was coated to the surface of the outer surface side of the rotated cylindrical mold by a dispenser in an environment of 23° C. and a relative humidity of 45% RH so that the feeding amount was 54 ml/min, a moving speed was 4.5 mm/sec, and a dried film had a thickness of 40 μm, thereby forming a lower layer coating film. Subsequently, after one minute after the coating of the lower layer was completed while continuing the rotation of the cylindrical mold, the coating solution for the upper layer was coated to the surface of the lower layer coating film by the dispenser so that the dried film had a thickness of 30 μm, thereby forming an upper layer coating film. Thus, a stacked coating film was obtained. Further, the environment of 23° C. and relative humidity of 45% RH was maintained from the time of coating the coating solution for the lower layer until the formation of the upper layer coating film.

[Heating and Drying Step and Mold Separating Step]

After the stacked coating film was formed, drying treatment was performed at 100° C. for 20 minutes, rotation of the cylindrical mold was stopped, and the stacked coating film was further subjected to a drying treatment at a temperature of 120° C. for 60 minutes. After cooling to room temperature (25° C.), the product was separated from the cylindrical mold to obtain a multilayer tubular article 1.

(Production of Multilayer Tubular Articles 2 to 6, 8, and 10 to 13)

Multilayer tubular articles 2 to 6, 8, and 10 to 13 were produced in the same manner except that the kinds of the solvent used were changed to the solvents listed in Table 1 below, respectively, in the preparation of the coating solution for the lower layer and the preparation of the coating solution for the upper layer of the production of the multilayer tubular article 1.

(Production of Multilayer Tubular Article 7)

[Preparation of Coating Solution for Lower Layer]

A dispersion of carbon black SPECIAL BLACK 4 (manufactured by Degessa) having a concentration of 25% by mass and dispersed in NMP with a bead mill was stirred and mixed with 200 g of a polyimide varnish solution containing a polyimide precursor (P1 precursor) as a main component (U-varnish A manufactured by Ube Industries, Ltd., polyamic acid having the number average molecular weight of 22,000, polyamic acid having the weight average molecular weight of 53,000, solvent NMP (N-methyl-2-pyrrolidone), and polyamic acid with a concentration of 14% by mass) so that an added amount of carbon black was 20 parts by weight with respect to 100 parts by weight of the polyamic acid solid content, thereby obtaining a polyimide precursor solution in which carbon black was dispersed. This solution was used as a coating solution for a lower layer.

[Preparation of Coating Solution for Upper Layer]

A polyimide precursor solution in which carbon black was dispersed was obtained in the same manner as in the coating solution for the lower layer except that the added amount of carbon black was changed to 10 parts by mass with respect to 100 parts by mass of the polyamic acid solid content. This solution was used as a coating solution for an upper layer.

[Coating Step, Heating and Drying Step, Firing Treatment and Mold Separating Step]

A multilayer tubular article 7 was obtained in the same manner as in the heating and drying step after continuous coating in the coating step in the coating step, the heating and drying step, and the mold separating step of the multilayer tubular article 1 except that, after the rotation of the cylindrical mold was stopped, firing treatment was performed at a temperature of 120° C. for 60 minutes, then at 150° C. for 30 minutes, then at 200° C. for 20 minutes, continuously at 250° C. for 20 minutes, and subsequently at 400° C. for 20 minutes, followed by cooling, and performing the mold separating step at a temperature of 40° C., instead of performing the drying treatment at 120° C. for 60 minutes after the rotation of the cylindrical mold was stopped and then performing the mold separating step at room temperature. Further, the environment of 23° C. and relative humidity of 45% RH was maintained from the time of coating the coating solution for the lower layer in the coating step until the formation of the upper layer coating film.

(Production of Multilayer Tubular Article 9)

[Preparation of Coating Solution for Lower Layer]

A polyimide precursor solution in which carbon black was dispersed was obtained in the same manner as in the preparation of the coating solution for the lower layer of the multilayer tubular article 7. This solution was used as a coating solution for a lower layer.

[Preparation of Coating Solution for Upper Layer]

A polyimide P solution in which carbon black was dispersed was obtained in the same manner as in the preparation of the coating solution for the upper layer of the multilayer tubular article 1, except that NMP was selected as the solvent (dissolvent) instead of THF. This solution was used as a coating solution for an upper layer.

[Formation of Lower Layer]

A cylindrical mold having an outer diameter (diameter of the coated surface of the cylindrical mold) of 240 mm and a length of 450 mm was set in a coating apparatus and then rotated at a peripheral speed of 500 mm/sec. Then, the coating solution for the lower layer was coated to the surface of the outer surface side of the rotated cylindrical mold by a dispenser so that the feeding amount was 54 mL/min, a moving speed was 4.5 mm/sec, and a dried film had a thickness of 40 μm, thereby forming a lower layer coating film. Subsequently, the lower layer coating film was dried at 100° C. for 20 minutes, then the rotation of the cylindrical mold was stopped, and the lower layer coating film was subjected to firing treatment at 120° C. for 60 minutes, then at 150° C. for 30 minutes, then at 200° C. for 20 minutes, continuously at 250° C. for 20 minutes, and subsequently at 400° C. for 20 minutes to obtain a lower layer.

[Formation of Upper Layer]

After cooling, the cylindrical mold having the lower layer formed on the outer peripheral surface was set in the coating apparatus and then rotated at a peripheral speed of 500 mm/sec. Then, the coating solution for the upper layer was coated to the surface of the lower layer on the rotated cylindrical mold by a dispenser so that the feeding amount was 54 mL/min, a moving speed was 4.5 mm/sec, and a dried film had a thickness of 30 μm, thereby forming an upper layer coating film. After the upper layer coating film was dried at 100° C. for 20 minutes, rotation of the cylindrical mold was stopped, and the stacked coating film was further subjected to a drying treatment at a temperature of 120° C. for 60 minutes. After cooling to room temperature, the product was separated from the cylindrical mold to produce the multilayer tubular article 9. Further, the environment of 23° C. and relative humidity of 45% RH was maintained from the time of coating the coating solution for the upper layer until the formation of the upper layer coating film.

Further, the produced multilayer tubular articles 1 to 13 were seamless.

<Measurement of Solvent Vapor Pressure>

For measurement of the vapor pressure at 25° C. of the solvent used, the gas flow method was used for NMP and the stop method was used for other solvents, respectively. Results thereof are shown in Table 1 below.

<Evaluation of Productivity>

For the production of each of the above-described multilayer tubular articles, the production amount per unit time and the yield were confirmed, considered in a comprehensive manner, and evaluated according to the following criteria. In this evaluation, it was determined that the following A and B showed good results. Results thereof are shown in Table 2 below.

[Evaluation Criteria]

A: the production amount per unit time is large and the yield is also very high since the drying treatment before forming the upper layer coating film after the formation of the lower layer coating film is not necessary, drying is easy, and the firing treatment is not necessary.

B: the production amount per unit time is large and the yield is also sufficient since the drying treatment before forming the upper layer coating film after the formation of the lower layer coating film is not necessary, drying is easy, and the firing treatment is not necessary.

C: the production amount per unit time is not sufficient since the drying treatment before forming the upper layer coating film after the formation of the lower layer coating film is not necessary but the drying treatment for a long time and/or at a high temperature is required.

D: the production amount per 1 hour is low since the drying treatment before forming the upper layer coating film after the formation of the lower layer coating film is not necessary but the drying treatment for a long time and/or at a high temperature is required, and the firing treatment is required after the drying treatment of the upper coat layer.

E: the production amount per unit time is very low since the drying treatment is required after formation of each layer, the drying treatment for a long time and/or at a high temperature is required, and the firing treatment is required as necessary after each layer is formed.

<Evaluation of Tubular Article>

(Evaluation of Peeling Durability)

For each of the multilayer tubular articles produced above, evaluation was performed by the cross-cut method according to JIS K5600-5-6:1999. Specifically, first, 11 cutting marks reaching lower layers were formed on the outer peripheral surface of each multilayer tubular article along each direction perpendicular to each other at an interval of 1 mm, thereby forming 100 grids (10 pieces×10 pieces). Subsequently, a cellophane tape was sufficiently pressed on the grid portion, and the cellophane tape was pulled toward an angle of 45° with respect to the surface at one time. In addition, the ratio (residual ratio) of the number of grids with no peeling of the upper layer was calculated and evaluated according to the following criteria. In this evaluation, it was determined that the residual ratio of 80% or more showed a good result. Results thereof are shown in Table 2 below.

(Evaluation of Surface Resistivity Variation)

With respect to each of the above produced multilayer tubular articles, a voltage of 500 V was applied, and after 10 seconds, the surface resistivity (Ω/□) of the outer peripheral surface was measured using a resistivity meter Hiresta UP manufactured by Mitsubishi Chemical Corporation and UR-SS as a measuring probe. The surface resistivity was measured at 20 different places in the same plane, and a difference between the maximum and the minimum of the common logarithm (log) of the measured surface resistivity of the 20 places was determined as a surface resistivity variation. Further, the unit of the obtained value was taken as (decimal place). In this evaluation, it was determined that 0.4 decimal place or less showed good results. Results thereof are shown in Table 2 below.

(Image Evaluation of Image Forming Apparatus)

Bizhub (registered trademark) C368 color multifunction machine which is an image forming apparatus manufactured by KONICA MINOLTA, INC. was prepared as an evaluation machine. Subsequently, each of the multilayer tubular articles produced above was mounted on the evaluation machine as an intermediate transfer body (intermediate transfer belt), and a solid image of Cyan halftone (gray scale 120) was output on neutral paper. Then, the obtained image was read using a scanner, the average concentration was calculated by image processing using Photoshop (registered trademark) (manufactured by Adobe, Inc.), and transferability was evaluated according to the following evaluation criteria. In this evaluation, it was determined that an area ratio of 3% or less with an average concentration of 90% or less showed good results. Results thereof are shown in Table 2 below.

[Evaluation Criteria]

A: Area ratio of an average concentration of 90% or less is 2% or less

B: Area ratio of an average concentration of 90% or less is more than 2% and 3% or less

C: Area ratio of an average concentration of 90% or less is more than 3% and 5% or less

D: Area ratio of an average concentration of 90% or less is more than 5%

TABLE 1
Prescription of coating solution for upper layer and coating solution for lower layer

| | Coating solution for lower layer | | | | Coating solution for upper layer | | | | |
|---|---|---|---|---|---|---|---|---|---|
| | | CB amount | | | | CB amount | | | |
| | | [parts by | | | | [parts by | | | |
| | | mass based | | | | mass based | | | |
| Multilayer | | on 100 parts | | Solvent | | on 100 parts | | Solvent | |
| tubular | | by mass | | vapor | | by mass | | vapor | |
| article | Polyimide | of resin | Solvent * | pressure | Polyimide | of resin | Solvent * | pressure | |
| No. | resin | component] | Note 1) | [kPa] | resin | component] | Note 1) | [kPa] | Remarks |
| 1 | Soluble PI | 20 | THF | 18.9 | Soluble PI | 10 | THF | 18.9 | Example 1 |
| 2 | Soluble PI | 20 | THF:Cyclo- | 18.9 (THF)/ | Soluble PI | 10 | THF:Cyclo- | 18.9 (THF)/ | Example 2 |
| | | | hexanone = | 0.5 (Cyclo- | | | hexanone = | 0.5 (Cyclo- | |
| | | | 90:10 | hexanone) | | | 90:10 | hexanone) | |
| 3 | Soluble PI | 20 | THF | 18.9 | Soluble PI | 10 | THF:Cyclo- | 18.9 (THF)/ | Example 3 |
| | | | | | | | hexanone = | 0.5 (Cyclo- | |
| | | | | | | | 90:10 | hexanone) | |
| 4 | Soluble PI | 20 | Cyclohexane | 10.3 | Soluble PI | 10 | Cyclohexane | 10.3 | Example 4 |
| 5 | Soluble PI | 20 | THF:Cyclo- | 18.9 (THF)/ | Soluble PI | 10 | THF | 18.9 | Example 5 |
| | | | hexanone = | 0.5 (Cyclo- | | | | | |
| | | | 90:10 | hexanone) | | | | | |
| 6 | Soluble PI | 20 | Cyclo- | 10.3 (Cyclo- | Soluble PI | 10 | Cyclo- | 10.3 (Cyclo- | Example 6 |
| | | | hexane:Cyclo- | hexane)/ | | | hexane:Cyclo- | hexane)/ | |
| | | | hexanone = | 0.5 (Cyclo- | | | hexanone = | 0.5 (Cyclo- | |
| | | | 90:10 | hexanone) | | | 90:10 | hexanone) | |
| 7 | PI precursor | 20 | NMP | 0.032 | PI precursor | 10 | NMP | 0.032 | Comparative |
| | | | | | | | | | Example 1 |
| 8 | Soluble PI | 20 | Acetone | 24 | Soluble PI | 10 | Acetone | 24 | Comparative |
| | | | | | | | | | Example 2 |
| 9 | PI precursor | 20 | NMP | 0.032 | Soluble PI | 10 | NMP | 0.032 | Comparative |
| | | | | | | | | | Example 3 |
| 10 | Soluble PI | 20 | THF:Cyclo- | 18.9 (THF)/ | Soluble PI | 10 | NMP | 0.032 | Comparative |
| | | | hexanone = | 0.5 (Cyclo- | | | | | Example 4 |
| | | | 90:10 | hexanone) | | | | | |
| 11 | Soluble PI | 20 | THF:Cyclo- | 18.9 (THF)/ | Soluble PI | 10 | Acetone | 24 | Comparative |
| | | | hexanone = | 0.5 (Cyclo- | | | | | Example 5 |
| | | | 90:10 | hexanone) | | | | | |
| 12 | Soluble PI | 20 | NMP | 0.032 | Soluble PI | 10 | THF:Cyclo- | 18.9 (THF)/ | Comparative |
| | | | | | | | hexanone = | 0.5 (Cyclo- | Example 6 |
| | | | | | | | 90:10 | hexanone) | |
| 13 | Soluble PI | 20 | Acetone | 24 | Soluble PI | 10 | THF:Cyclo- | 18.9 (THF)/ | Comparative |
| | | | | | | | hexanone = | 0.5 (Cyclo- | Example 7 |
| | | | | | | | 90:10 | hexanone) | |

* Note 1)
x:y represents content ratios (% by mass) of respective solvent when the total mass of the solvent is set as 100% by mass.

TABLE 2
Coating method and evaluation results of produced tubular article

| | | | | | | Evaluation results of tubular article | | | |
|---|---|---|---|---|---|---|---|---|---|
| | | | | | | | Surface | | |
| Multilayer | | | Lower layer | Upper layer | | | resistivity | Image of | |
| tubular | Method for | Heating | dried film | dried film | Productivity | Peeling | deviation | image | |
| article | forming stacked | and firing | thickness | thickness | evaluation | durability | [decimal | forming | |
| No. | coating film | treatment | [μm] | [μm] | result | [%] | place] | apparatus | Remarks |
| 1 | Continuous coating | Not performed | 40 | 30 | A | 80 | 0.3 | B | Example 1 |
| 2 | Continuous coating | Not performed | 40 | 30 | B | 100 | 0.2 | A | Example 2 |
| 3 | Continuous coating | Not performed | 40 | 30 | B | 80 | 0.3 | B | Example 3 |
| 4 | Continuous coating | Not performed | 40 | 30 | A | 96 | 0.2 | A | Example 4 |
| 5 | Continuous coating | Not performed | 40 | 30 | B | 95 | 0.3 | B | Example 5 |
| 6 | Continuous coating | Not performed | 40 | 30 | A | 100 | 0.2 | A | Example 6 |
| 7 | Continuous coating | Performed | 40 | 30 | D | 96 | 0.8 | D | Comparative |
| | | | | | | | | | Example 1 |
| 8 | Continuous coating | Not performed | 40 | 30 | A | 60 | 0.6 | C | Comparative |
| | | | | | | | | | Example 2 |
| 9 | Upper layer coating | Performed | 40 | 30 | E | 60 to 72 | 0.3 | A | Comparative |
| | film formation after | | | | | | | | Example 3 |
| | heating and drying | | | | | | | | |
| | treatment of lower | | | | | | | | |
| | layer coating film | | | | | | | | |
| 10 | Continuous coating | Not performed | 40 | 30 | C | 100 | 0.5 | B | Comparative |
| | | | | | | | | | Example 4 |
| 11 | Continuous coating | Not performed | 40 | 30 | B | 60 | 0.5 | C | Comparative |
| | | | | | | | | | Example 5 |
| 12 | Continuous coating | Not performed | 40 | 30 | C | 100 | 0.2 | A | Comparative |
| | | | | | | | | | Example 6 |
| 13 | Continuous coating | Not performed | 40 | 30 | C | 80 | 0.6 | C | Comparative |
| | | | | | | | | | Example 7 |

From the results shown in Table 2, it was confirmed that the method for producing the multilayer tubular articles of Examples 1 to 6 according to the present invention had excellent productivity and better performance of the multilayer tubular article to be produced. Further, it was confirmed that in the method for producing the multilayer tubular articles of Comparative Examples 1 to 7 out of the range of the present invention, at least one of the productivity and the performance of the multilayer tubular articles thereof was inferior to that of the present invention.

In addition, among the production method of the Examples, it was confirmed that the multilayer tubular articles produced by the production methods of Examples 2, 4, and 6 exhibited better results, and the multilayer tubular articles produced by the production methods of Examples 4 and 6 exhibited remarkably excellent results.

In addition, it was confirmed that the production method of Example 6 was excellent not only in productivity but also in the properties at the time of use, particularly, peeling durability.

Although embodiments of the invention have been described in detail, it is to be understood that these are illustrative and exemplary and not restrictive, and it is obvious that the scope of the invention is to be interpreted by the appended claims.
1 image forming apparatus
1Y, 1M, 1C, 1K photoreceptor
2Y, 2M, 2C, 2K charging means (charging units)
3Y, 3M, 3C, 3K exposing means (exposing units)
4Y, 4M, 4C, 4K developing means (developing units)
4Y1, 4M1, 4C1, 4K1 developer carrier
5Y, 5M, 5C, 5K primary transfer roller
5A secondary transfer roller
6A, 6Y, 6M, 6C, 6K cleaning means (cleaning units)
7 seamless belt-type intermediate transfer body forming unit
8 case
10Y, 10M, 10C, 10K image forming unit
11Y, 11M, 11C, 11K means for applying fatty acid metal salt (units for applying fatty acid metal salt paper feeding cassette)
20 paper feeding cassette
21 paper feeding conveying means (paper feeding conveying units)
22A, 22B, 22C, 22D intermediate roller
23 resist roller
24 belt type fixing device
25 paper ejecting roller
26 paper ejecting tray
70 intermediate transfer belt
71, 72, 73, 74, 76, 77 roller
82L, 82R support rail
270 heat roller fixer
A main body
P recording medium
SC original image reading device
100 cylindrical mold
100A outer peripheral surface of cylindrical mold
100B inner peripheral surface of cylindrical mold
101 discharge member or discharge part
300 multilayer tubular article
301 other polyimide resin layer (polyimide resin layer other than polyimide resin layer disposed on outermost peripheral side)
302 polyimide resin layer disposed on outermost peripheral side
B cross-sectional direction

What is claimed is:

1. A method for producing a tubular article comprising:
continuously coating at least two coating solutions for forming a polyimide resin layer to form a stacked coating film, the two coating solutions each including: a solvent-soluble polyimide; and a solvent having a vapor pressure at 25° C. of 10 kPa or more and 19 kPa or less.

2. The method for producing a tubular article according to claim 1, wherein the coating includes forming the stacked coating film on an inner peripheral surface or an outer peripheral surface of a cylindrical mold,
the method, further comprising, after the coating,
heating the stacked coating film to form a dried coating film; and
separating the heated and dried coating film from the cylindrical mold.

3. The method for producing a tubular article according to claim 1, wherein in the coasting, the at least two coating solutions for forming a polyimide resin layer are coated using dice or a dispenser.

4. The method for producing a tubular article according to claim 1, wherein at least one of the at least two coating solutions for forming a polyimide resin layer further includes a conductive agent.

5. The method for producing a tubular article according to claim 1, wherein the solvent-soluble polyimide has a structural unit represented by Chemical Formula (1) below: 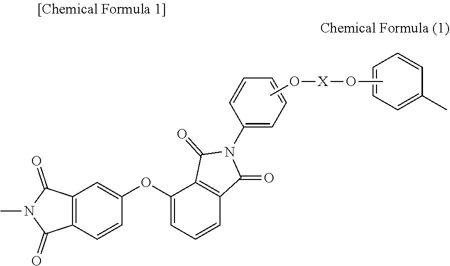
in Chemical Formula (1), X represents a divalent group having 7 or more and 25 or less carbon atoms.

6. The method for producing a tubular article according to claim 1, wherein the tubular article is an intermediate transfer belt.
